(19) United States
(12) Patent Application Publication
(10) Pub. No.: US 2002/0043515 A1
(43) Pub. Date: Apr. 18, 2002

(54) Vacuum switch and vacuum switchgear using the same

(76) Inventors: Satoru Kajiwara, Hitachi (JP); Toru Tanimizu, Hitachi (JP); Yoshiyasu Watanabe, Hitachi (JP); Takuya Okada, Hitachi (JP); Yoshitomo Goto, Hitachi (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/022,237

(22) Filed: Dec. 20, 2001

Related U.S. Application Data
(62) Division of application No. 09/463,329, filed on Jan. 24, 2000.
Application No. 09/463,329 is a 371 of international application No. PCT/JP99/04116, filed on Jul. 30, 1999.

(30) Foreign Application Priority Data
Oct. 5, 1998 (JP) 10-282201

(51) Int. Cl. H01H 33/66

(52) U.S. Cl. 218/118

(57) ABSTRACT

An object of the present invention is to provide vacuum switch suitable for a distribution and transformation system compatible between structural simplicity and reliability and a vacuum switchgear using the vacuum switch.

In order to attain the above object, the vacuum switch is formed by containing switching portions into a vacuum container, and comprises a breaker, a grounding switch and an isolator as the switching portions, wherein the vacuum container is separated into at least two chambers, and the switching portion of the breaker is disposed in one of the chambers, and the switching portions of the grounding switch and the isolator are disposed in the other of the chambers.

### FIELD OF THE INVENTION

The present invention relates to a vacuum switch and a vacuum switchgear using the vacuum switch and, more particularly a vacuum switch suitable for a distribution and transformation system compatible between structural simplicity and reliability and a vacuum switchgear using the vacuum switch.

### BACKGROUND OF THE INVENTION

In regard to increasing demand of power consumption in a congested urban district, there are problems such as difficulty of obtaining a site for a distribution substation, lack of installation room for wire ducts, and requirement for a high operability of a supply facility. In order to solve these problems, it is necessary that the voltage is increased, that is, that load is actively absorbed in a voltage system having a large capacity per line. Increase in distribution voltage relates to forming of an effective electric power supply system. Therefore, it is necessary to make the distribution components and the distribution and transformation facility further compact.

As for the distribution and transformation components to be made compact, there is an SF₆ gas insulation switchgear disclosed in, for example, Japanese Patent Application Laid-Open No. 3-273804. The switchgear is formed by that a breaker, two isolators and a grounding switch individually fabricated are contained in a unit chamber and a bus chamber of power distribution containers filled with an insulation gas.

The distribution and transformation facility having a gas insulation switchgear receives electric power transmitted from, for example, an electric power company using a gas insulation breaker and the like, transforms the electric power to a voltage appropriate for loads, and the electric power is supplied to the loads, for example, a motor or the like. When maintenance and inspection of the distribution and transformation facility are performed, after a gas insulation breaker is switched off, an isolator provided separately from the gas insulation breaker is opened. Then, residual charge and induced current are to let to flow to the ground by grounding a grounding switch and re-application from the power supply is prevented to secure safety of workers. Further, since an accident will occur when the grounding switch is grounded while the bus is charged, an interlock is provided between the breaker and the grounding switch.

The SF₆ gas used as the insulation gas of the gas insulation switch is globally reducing to be used from the viewpoint of environmental effects. Therefore, a switchgear without using SF₆ gas is required.

An object of the present invention is to provide a vacuum switch without using any insulation gas aware of environmental effects, and to provide a vacuum switchgear using the vacuum switch. Another object of the present invention is to provide a substantially small sized vacuum switch and a vacuum switchgear using the vacuum switch.

A further object of the present invention is to provide a vacuum switch which does not immediately lose the whole function even if vacuum break occurs in a part of the vacuum switch, and can maintain part of the function, and to provide a vacuum switchgear using the vacuum switch. A further object of the present invention is to individually provide a switchgear composed of only a portion of a breaker, and a switchgear composed of only portions of a grounding switch and an isolator.

### SUMMARY OF THE INVENTION

The present invention relates to a vacuum insulation switchgear using a grounded vacuum switch. In detail, a breaker, an isolator, a grounding switch and a bus connected to a load outside a vacuum container are disposed in the gas-tightly sealed vacuum container. One end of the breaker is formed in a movable electrode, and a fixed electrode is disposed so as to connect with and disconnect from the movable electrode. The fixed electrode is connected to a electric power system.

In the present specification, the switch means a machine which performs making and breaking between the fixed electrode and the movable electrode. The switchgear means a machine which comprises a control gear and contains a combination of one or more switching units, one or more units among a operating, a measurement, a protecting and an adjusting units, and internal connections in an enclosed box. Further, in the present specification, in addition to the structures described above, the switchgear further comprises a group of these machines and units having accessories and supporting structures, and furthermore comprises a control portion for controlling the operating mechanism.

The breaker in the present application is a switchgear which is used for immediately isolating a position of occurrence of ground-fault or short-circuit in an electric power system from the system to prevent damage of a machine connected in series caused by a large current and to preventing damage of a failed machine by an arc. The isolator a machine which performs switching of a charged electric path though it does not have breaking ability of a large current, and used for ensuring to isolate from a power supply when the circuit connection is changed or machines are maintained or inspected. There are various kinds of isolators for low voltage to high voltage. The grounding switch is a switching machine for ensuring safety by grounding conductors under a null-voltage condition during inspection and maintenance. The breaker can break all of charged current, normal current, abnormal current. The isolator can break charged current, but can not break both of normal current and abnormal current. The grounding switch can break none of charged current, normal current, abnormal current.

A vacuum switch in accordance with the present invention is characterized by a vacuum switch which is formed by containing switching portions into a vacuum container, and comprises a breaker, a grounding switch and an isolator as the switching portions, and the vacuum container is separated into at least two chambers, the switching portion of the breaker being disposed in one of the chambers, the switching portions of the grounding switch and the isolator being disposed in the other of the chambers. Further, one end of the breaker and a main circuit member (including a bus and a connecting part) led outside the vacuum container are electrically connected to each other with a flexible member, and/or one end of the grounding switch and one end of the isolator are electrically connected to each other with a flexible member.

Although the vacuum switchgear preferably has two chambers last of all, the vacuum switchgear may be separated into a product of a portion of only the breaker and a product of a portion of the isolator and the grounding switch depending on need. That is, in this case, the vacuum switchgear becomes one product that the breaker is disposed in a vacuum container and the one end of the breaker and a main circuit member led outside the vacuum container are electrically connected to each other with a flexible member, and the other product that the isolator and the grounding switch are disposed in a single vacuum container and one end of the grounding switch and one end of the isolator are electrically connected to each other with a flexible member.

Of course, it is in the cope of the present invention that these products are separately manufactured and installed. It is also in the cope of the present invention that products separately purchased are combined, or a product is connected to an existing facility. Further, in regard to the vacuum switchgear, the vacuum breaker and the electric facility in accordance with the present invention, it is preferable that these parts are temporarily assembled outside a furnace, and then a vacuum bulb and parts inside the bulb are heated in the vacuum chamber to be soldered. For example, it is preferable that the flexible member is formed by assembling a plurality of plate-shaped members interposing solder material between them, and heating the plate-shaped members in the vacuum chamber after temporarily assembling the parts to melt the solder material to join the plate-shaped members. Although a flexible conductor composed of laminated plates is shown, here, as the flexible member, in the present application a flexible conductor composed of bellows is also applicable.

Further, in another embodiment of the present invention, a shape of the bushings is also taken into consideration. That is, a vacuum switchgear is formed by containing switching portions into a vacuum container, and comprises a breaker, a grounding switch and an isolator as the switching portions, the vacuum container being separated into at least two chambers, the switching portion of the breaker being disposed in one of the chambers, the switching portions of the grounding switch and the isolator being disposed in the other of the chambers, main circuit conductors and voltage detecting conductors being projected outward from the vacuum chamber having the switching portion of the breaker, main circuit conductors being projected outward from the vacuum chamber having the switching portion of the isolator, a projecting portion of each of the conductors being formed in a bushing covered with an electric insulating member, at least two of the bushings being formed in an equal shape. Of course, it is further effective if this embodiment is combined with the application of the flexible member described above.

It is preferable that the flexible member used in the present invention has a strength capable of withstanding a necessary current capacity, and is made of oxygen-free copper. Further, it is preferable that the flexible member is a flexible conductor which is formed by laminating a plurality of oxygen-free copper plates and soldering both ends of the laminated plates.

In order to secure the performance, the degree of vacuum is necessary to be 10⁻⁶ to 10⁻⁹ torr.

### BRIEF DESCRIPTION OF DRAWINGS

FIG. 1 is a perspective view showing an embodiment of vacuum switch in accordance with the present invention.

FIG. 2 shows an embodiment of a vacuum switchgear in accordance with the present invention, (A) is a cross-sectional side view showing the vacuum switchgear in a state of the breaker “ON”, the grounding switch “OFF” and the isolator “ON”, and (B) is a partially cross-sectional top plan view showing the vacuum switchgear in the same state.

FIG. 3 shows an embodiment of a vacuum switchgear in accordance with the present invention, (A) is a cross-sectional side view showing the vacuum switchgear in a state of the breaker “OFF”, the grounding switch “OFF” and the isolator “ON”, and (B) is a partially cross-sectional top plan view showing the vacuum switchgear in the same state.

FIG. 4 shows an embodiment of a vacuum switchgear in accordance with the present invention, (A) is a cross-sectional side view showing the vacuum switchgear in a state of the breaker “OFF”, the grounding switch “ON” and the isolator “OFF”, and (B) is a partially cross-sectional top plan view showing the vacuum switchgear in the same state.

FIG. 5 shows an embodiment of a vacuum switchgear for three-phase in accordance with the present invention, (A) is a cross-sectional side view showing the vacuum switchgear in a state of the breaker “ON”, the grounding switch “OFF” and the isolator “ON”, and (B) is a top plan view showing the vacuum switchgear in the same state, and (C) is a bottom view showing the vacuum switchgear in the same state.

FIG. 6 a cross-sectional side view showing an embodiment of a vacuum switchgear for three-phase in accordance with the present invention, the vacuum switchgear being in a state of the breaker “OFF”, the grounding switch “OFF” and the isolator “ON”.

FIG. 7 is a perspective view showing the outer appearance of a flexible conductor used in the systems of FIG. 1 to FIG. 6.

### DESCRIPTION OF THE PREFERRED EMBODIMENTS

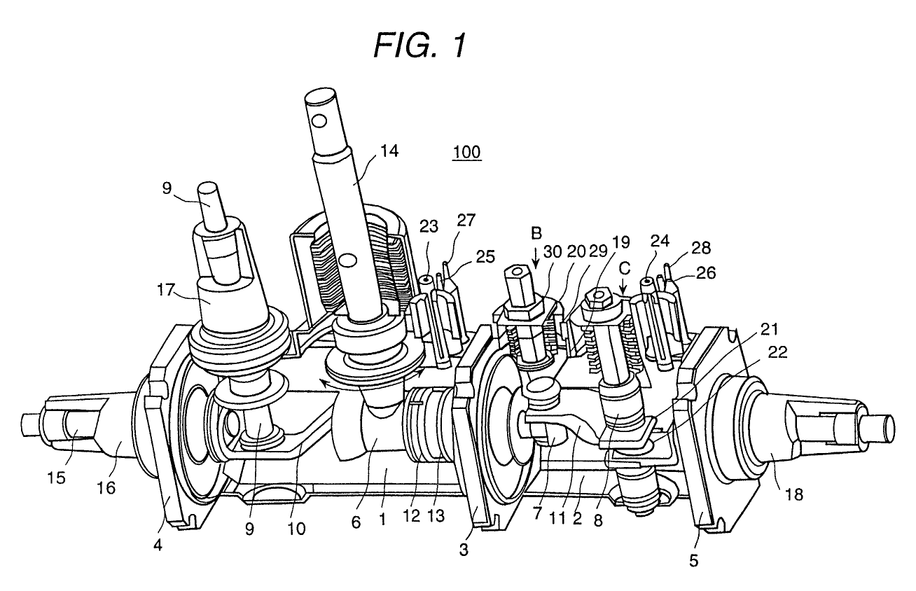

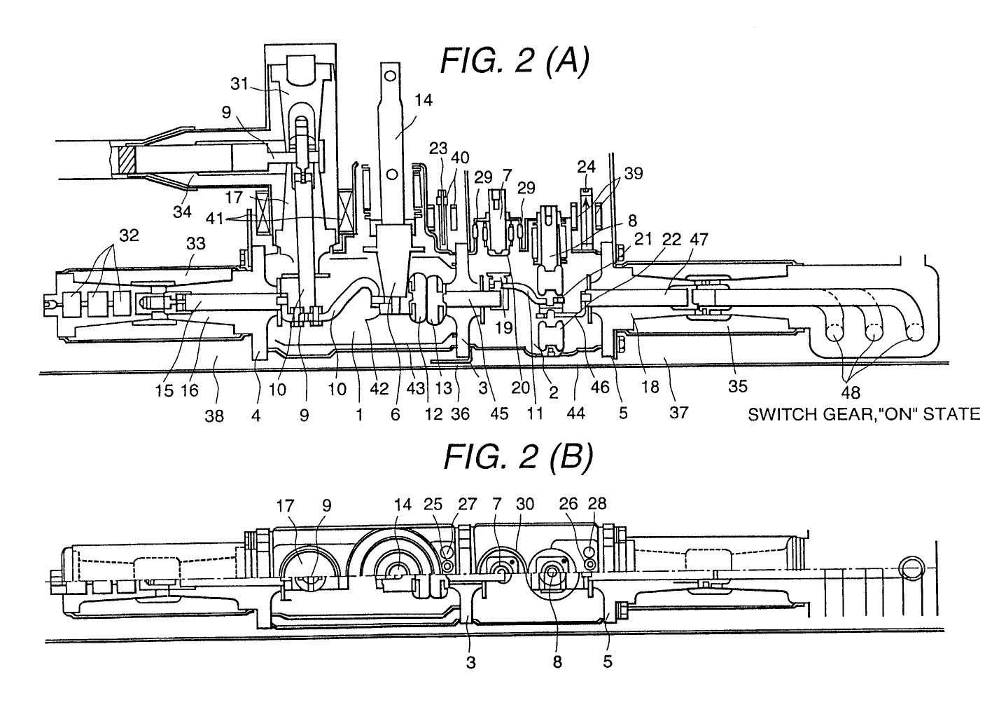

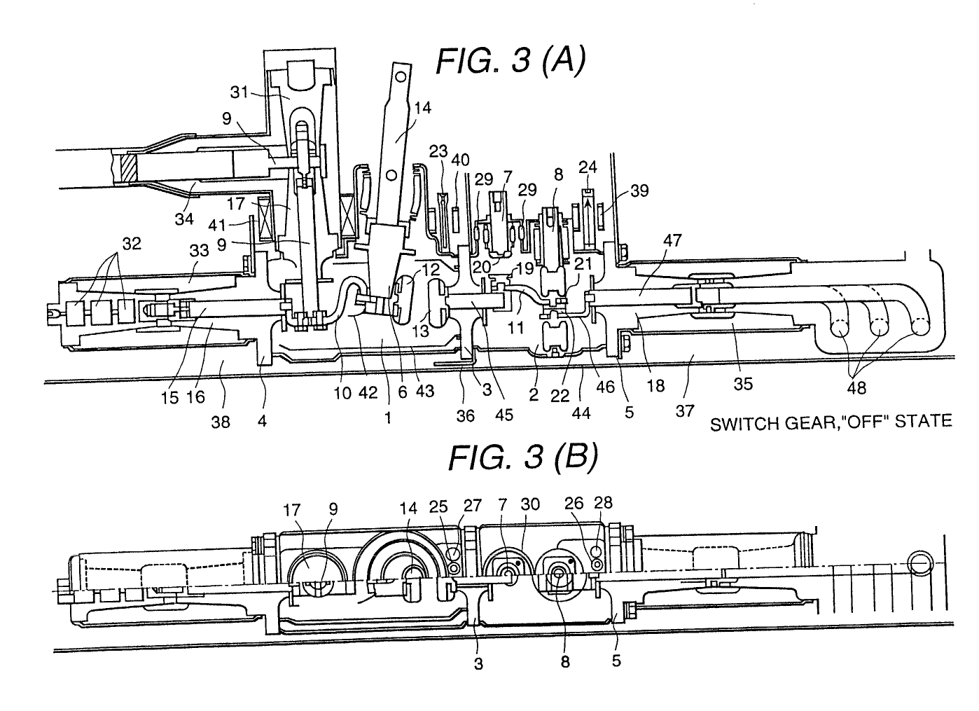

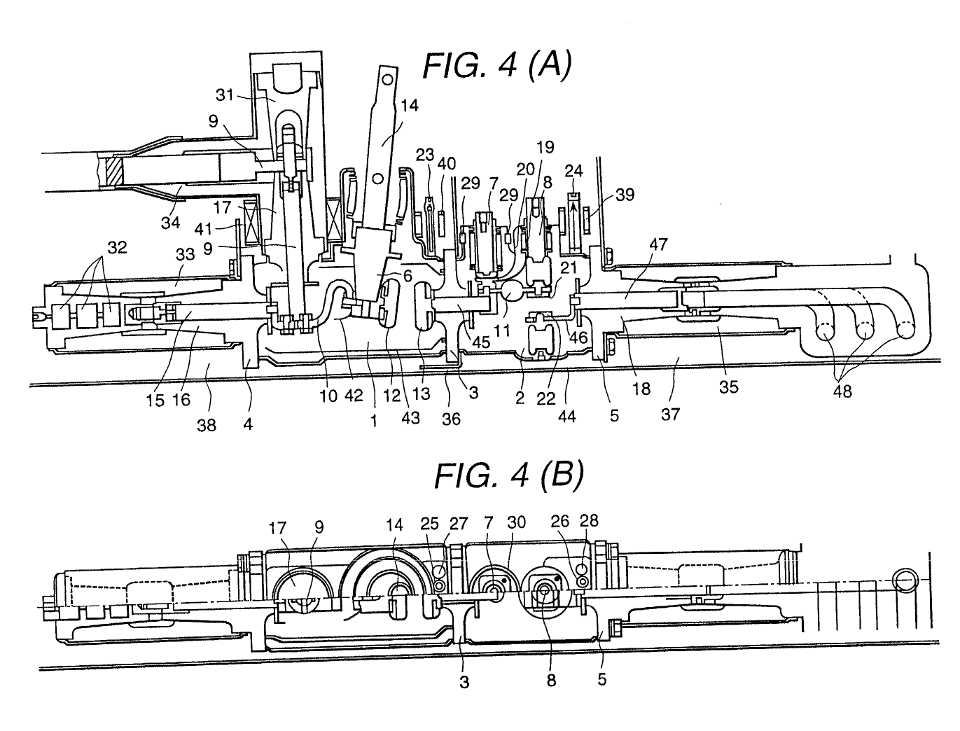

Embodiments of the present invention will be described below, referring to the accompanied drawings. FIG. 1 is a perspective view showing an embodiment of a vacuum switch in accordance with the present invention. This example shows a case of one phase. For the purpose of simplifying explanation, a bus portion, a feeder side and parts in the terminal portions such as covers, plugs are omitted in FIG. 1. FIG. 2 is a cross-sectional side view and a partially cross-sectional and partially plan view showing the vacuum switchgear in a state of the breaker “ON”, the grounding switch “OFF” and the isolator “ON”. Similarly, FIG. 3 shows the vacuum switchgear in a state of the breaker “OFF”, the grounding switch “OFF” and the isolator “ON”. Further, FIG. 4 similarly shows the vacuum switchgear in a state of the breaker “OFF”, the grounding switch “ON” and the isolator “OFF”.

First of all, the vacuum chamber of the present embodiment of the vacuum switchgear is divided into two sections of a first vacuum chamber 1 and a second vacuum chamber 2 with a partition wall 3. The partition wall 3 is made of a ceramic of electric insulator. Each of the vacuum chambers 1, 2 is formed in a gas-tight structure with a casing in the side surface of the switchgear (not shown in the figure) and flange portions 4, 5 of the bushings. That is, the flange portions 4, 5 also serve as end walls of the vacuum chamber to form these walls, and are made of a ceramic of electric insulator similar to the partition wall 3.

Inside the first vacuum chamber 1, a breaker 6 is disposed, and a main circuit conductor 9 is also disposed. Each of them is formed so as to project upward from the casing. An operating rod 14 extends upward in the breaker 6, and a bushing 17 covered with epoxy resin is formed above the main circuit conductor 9. A movable side electrode 12 is formed in one end of the breaker 6, and the other end is electrically connected to the main circuit conductor 9 with a flexible conductor 10. The flexible conductor 10 is mechanically fastened to an lower end of the main circuit conductor 10 using screw or the like. A fixed side electrode 13 is arranged opposite to the movable side electrode 12, and the breaker 6 is formed including the fixed electrode 13. An arrow A in the figure indicates an operating direction of the operating rod, and according to this motion the state of breaker “ON” shown in FIG. 2 (that is, the conduction state that the fixed side electrode 13 is in contact with the movable side electrode 12) or the state of breaker “OFF” shown in FIG. 3 (that is, the state that the operating rod 14 is slanted and the fixed side electrode 13 is out of contact with the movable side electrode 12) is formed. A vacuum gauge 23, a gas absorption column 25 and an exhaust gas pipe 27 are installed on the top surface of casing of the first vacuum chamber 1. The operating rod is operated when a fault current flows or when an OFF command is output from an operation machine (when the breaker is intentionally broken for the purpose of maintenance or inspection).

Further, an insulation plug 31 is arranged on the top of the bushing 17, and the main circuit conductor 9 is bent at a position before the plug 31 and led to an main circuit (bus). The main circuit conductor 9 from the bent portion toward the leading direction of the bus is covered with rubber 34 for insulation. A current transformer 41 is arranged around the bushing 17, and the current transformer 41 detect a current flowing the main circuit so that the breaker is immediately broken when an abnormal current flows.

An top end of the flexible conductor 10 is electrically connected to a voltage detection conductor 15, and the voltage detection conductor 15 is covered with a bushing 16. The bushing 16 is made of epoxy resin similarly to the other bushings. Capacitors 32, three capacitors in this embodiment, arranged in series are disposed at a top end of the voltage detection conductor 15. A further outer side of the busing 16 is covered with insulation rubber 33.

A magnet 40 is arranged in ring shape around the vacuum gauge 23. An arc preventive cover 42 is disposed at a position near the breaker side connection portion of the flexible conductor 10, and further an arc preventive cover 43 is also disposed in a semi-cylindrical shape around that portion so as to cover most part of a lower inner wall of the casing 44. The partition wall 3 is attached to the inner wall of the casing 44 with an attaching clamp 36.

In the second vacuum chamber 2, the grounding switch 7, the isolator 8 and the vacuum container end portion wall 5 (that is, the flange portion of the bushing 18) are sequentially arranged from the partition wall 3 side, and further the busing 18 is arranged in the outer side of the end portion. The grounding switch 7 has a portion mechanically movable in a direction shown by an arrow B, that is, vertically movable, and a movable side electrode 20 is formed in the lower end of the portion. A fixed side electrode 19 is arranged opposite to the movable side electrode 20, and the fixed side electrode 19 and the fixed side electrode 13 of the breaker 6 are electrically connected each other with an electric connecting portion 45 penetrating through the partition wall 3. The grounding switch 7 is vertically moved as shown by the arrow B to perform grounding by making between the fixed side electrode 19 and the movable side electrode 20 and to perform releasing of grounding by breaking between them. The concept is that the grounding switch 7 includes the fixing side electrode 13.

The isolator 8 also has a portion mechanically movable in a direction shown by an arrow C. A movable side electrode 21 is formed in the lower end of the vertical move portion, and a fixed side electrode 22 is arranged opposite to the movable side electrode 21. The making and breaking state is determined by the vertical movement C. the fixed side electrode 19 of the grounding switch 7 and the movable side electrode 21 of the isolator 8 are connected to each other with a flexible conductor 11. The fixed side electrode 22 is connected to a main circuit conductor 47 with an electric connecting portion 46, and connected to a main circuit conductor 48 (bus) through the main circuit conductor 47.

Explaining a series of the conducting relationship referring to FIG. 4, the state of FIG. 4 is a state of breaker “OFF” since the movable side electrode 12 of the breaker is out of contact with the fixed side electrode 13. The movable side of the breaker 6 is in a state of being connected to the main circuit conductor 9 and the voltage detecting conductor 15 through the flexible conductor 10. The grounding switch 7 is in the grounding state since the movable side electrode 20 is in contact with the fixed side electrode 19. The isolator 8 is in the breaking state since the movable side electrode 21 and the fixed side electrode 22 are apart from each other in a distance sufficient enough to break the circuit. The fixed side electrode 22 is led to the bus, as described above.

A vacuum gauge 24, a gas absorbing column 26 and an exhaust gas pipe 28 are installed on the top surface of casing of the second vacuum chamber 2. The reference character 29 is an insulating ceramic body. A magnet 39 is arranged in ring shape around the vacuum gauge 24. An insulating measure is performed be arranging rubber 35 around the bushing 18. The reference characters 37, 38 indicate air, that is, outer air communicating portions.

The bushing 16 and the bushing 18 are fixed with screws to the casing using the flange portions 4, 5, respectively. The both bushings are the same in dimensions and shape and in material, that is, common parts. Further, the shape and dimensions of the top end (a portion excluding the portion corresponding to the flange position) of the bushing is the same as those of the bushings 16, 18. The commonality of parts described above results cost reduction. Thereby, arrangement of the bus portion, the feeder portion and the voltage detecting portion can change depending on a customer's need.

The ceramic body 30 is for insulating so that current flows through the vacuum container when withstanding voltage of a cable is inspected by letting current flow from the grounding side.

The vacuum gauges 23, 24 utilize the magnetron principle. The magnets 39, 40 are incidental parts for the equipments, and arranged in a pipe shape to form a magnetic field at measuring a vacuum degree. However, the vacuum chambers 1, 2 are gas-tightly manufactured so as to maintain the vacuum degree for 20 years or longer under a normal using condition.

The grounding switch 7 and the isolator 8 are operated by an operating machine different from that for the breaker 6.

The gas absorbing columns 25, 26 are also called as getters. The exhaust gas pipes 27, 28 are for evacuation, that is, for recovery.

In a case where there are two vacuum chambers as in this embodiment, since one of the vacuum chamber maintains vacuum even if vacuum break occurs in the other of the chambers, the system does not immediately lose the whole function. Further, in regard to distribution of products, it is effective that the unit of the first vacuum chamber 1 and the unit of the second vacuum chamber 2 are separately manufactured and installed, or one of them replaces a corresponding existing part, or the both are assembled and joined in place.

The system of the present embodiment is assembled in a vacuum, that is, soldering work is performed to obtain a product by inserting parts temporarily assembled outside into a furnace and heating up them in a vacuum to melt solder and bond appropriate positions together. All bonding between the ceramic body and the vacuum container is performed by soldering, and the plates composing the flexible conductors 10, 11 to be described below are also bonded together through soldering.

In the system of the present embodiment, the flexible conductors 10, 11 are employed. By doing so, conduction of current can be certainly performed during operation, and the structure can be simplified because current can be certainly conducted during rotating motion and during vertical motion. If the flexible conductors 10, 11 are installed outside the vacuum container, current flows in the flexible conductors 10, 11 and it is dangerous unless the portions outside the vacuum container are insulated by covering with SF₆ gas or a solid insulator. Therefore, by installing the flexible conductors 10, 11 in the vacuum container, safety can be ensured, and the system can be made compact.

It is preferable that the current conducting area of the flexible conductor 10 or 11 is at least 200 mm², and the necessary current capacity is a strength capable of withstanding 25 kA for 1 second.

In the present embodiment, the lower portion of the main circuit conductor 9 and the voltage detecting conductor 15 are electrically connected each other with the flexible conductor 10. This is effective use of an extra portion of the flexible conductor 10 extending from the breaker 6 of which the middle portion is fixed to the main circuit conductor 9. Therefore, there is no need to use a flexible conductor in connection between the voltage detecting conductor and the main circuit conductor. This is because the both are in a fixed positional relation, and accordingly there is no necessity to be flexible. Similarly, the electric connecting portion 46 is not necessary to be a flexible conductor.

FIG. 7 shows the outer appearance of the flexible conductor. The flexible conductor 10 or 11 related to the present embodiment is formed by laminating a plurality of oxygen-free copper plates, interposing a solder material between the plates each, and soldering the both ends as shown in FIG. 7. The soldered portions are used as attaching portions to the electrodes or the conductors. The conductor 10 is composed of 70 plates of 120 to 130 mm length, 30 mm width and 0.1 mm thickness. The soldered portions are used as attaching portions to the electrodes or the conductors. The conductor 11 is composed of 50 plates of 60 to 70 mm length and the other dimensions are the same as those of the conductor 10, that is, the length of the conductor 10 following to rotating movement is longer.

In the present embodiment, description has been made on the vacuum switch which is composed of the vacuum container divided into two chambers, the breaker having the switching portion gas-tightly sealed in one of the vacuum chamber, and the isolator and the grounding switch having the switching portions gas-tightly sealed in the other of the vacuum chamber. It may be possible to consider a vacuum switch which is composed of a vacuum container and a breaker having the switching portion gas-tightly sealed in the vacuum container, or a vacuum switch which is composed of a vacuum container and an isolator and a grounding switch having the switching portions gas-tightly sealed in the vacuum container. In these cases, similar to the above-mentioned embodiment, the flexible members similar to those in the above-mentioned embodiment are used in electric connection between the main circuit and the switching portion or electric connection between the switching portions.

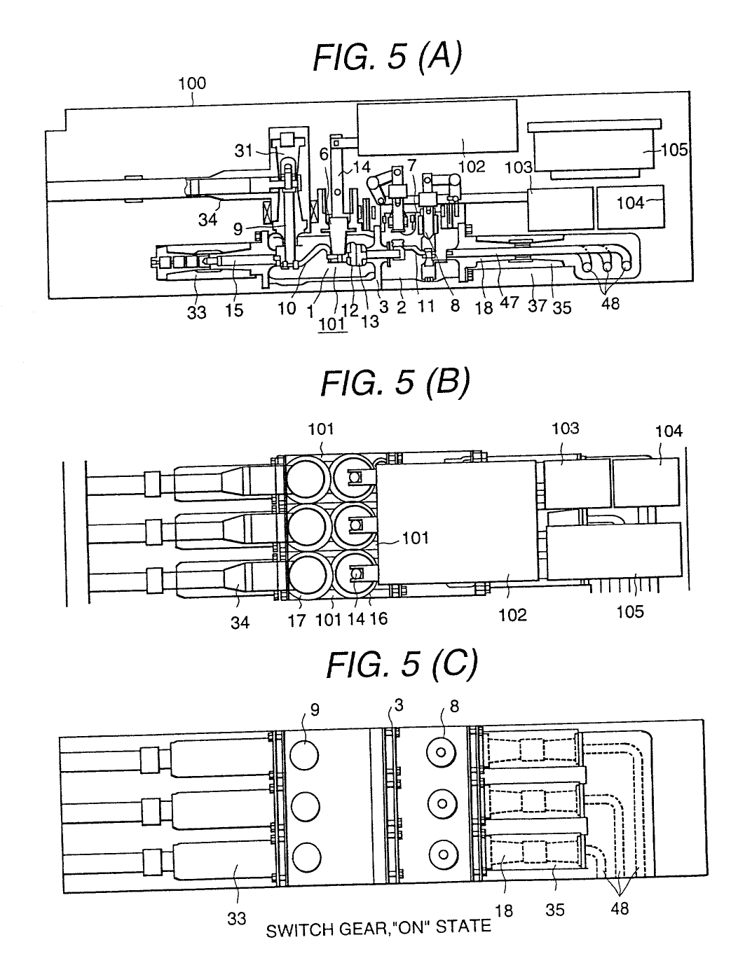

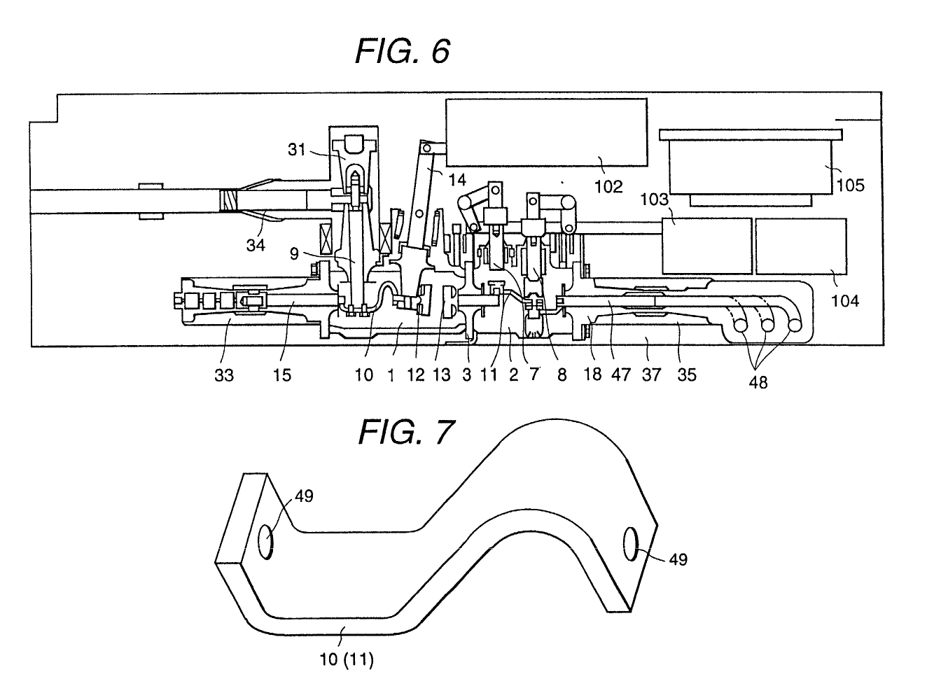

Although the above is the embodiment of one phase, an embodiment of three phase will be described below, referring to FIG. 5 and FIG. 6. Referring to the figures, the reference character 100 is a metallic containing cubicle. The vacuum switches 101 for three phases of U, V, W are contained in the containing cubicle 100. Each of the vacuum switches 101 for three phases is the same structure as the vacuum switch of the above-mentioned embodiment, and comprises the breaker 6 having the breaking function, the grounding switch 7 having grounding function and the isolator 8 having the isolating function. A main circuit conductor (bus) 48 is electrically connected to one end of each of the vacuum switches 101, and a main circuit conductor 9 is electrically connected to the other end of each of the vacuum switches 101. The containing cubicle 100 contains operating compartments 102, 103, 104 respectively containing operating mechanisms for the breakers 6, the grounding switchs 7 and the isolators 8 and a protective control unit 105 for outputting control commands to each of the operating mechanisms. The operating mechanisms are constructed so as to operate the breakers 6, the grounding switchs 7 and the isolators 8 three phases together, respectively. The operating compartments 102, 103, 104 and the protective control unit 105 are arranged in a space above the main circuit conductors 48 of the vacuum switches 101.

As described above, the vacuum switchgear is composed of the containing cubicle 100, the vacuum switches 101 for three phases, the main circuit conductors 9, 48, the operating compartments 102, 103, 104 and the protective control unit 105.

The vacuum switch and the vacuum switchgear in accordance with the present invention have effects that they are excellent in pollution control measures and they can attain small-sizing. The switchgear having two vacuum chambers is highly reliable in the point that one can maintain vacuum when vacuum of the other chamber is broken. Further, since vacuum condition may be formed not only the whole system but also part of the system, for example, only breaker portion, a product type corresponding to a need and an economical product can be formed.

Application of the flexible member to the breaker side contributes to compactness of the system though rotating movement and current conduction of the breaking mechanism (switch) can be certainly performed, and application of the flexible member between the grounding switch and the isolator contributes to certainty of current conduction and compactness of the system.

Furthermore, commonality of bushing dimension and shape is effective for cost reduction by commonality of parts.

What is claimed is:

1. A vacuum switch which is formed by containing switching portions into a vacuum container, and comprises a breaker, a grounding switch and an isolator as said switching portions, said vacuum container being separated into at least two chambers, the switching portion of said breaker being disposed in one of said chambers, the switching portions of said grounding switch and said isolator being disposed in the other of said chambers.

2. A vacuum switch which is formed by containing switching portions into a vacuum container, and comprises a breaker, a grounding switch and an isolator as said switching portions, said vacuum container being separated into at least two chambers, the switching portion of said breaker being disposed in one of said chambers, the switching portions of said grounding switch and said isolator being disposed in the other of said chambers, one end of said breaker and a main circuit member led outside said vacuum container being electrically connected to each other with a flexible member.

3. A vacuum switch which is formed by containing switching portions into a vacuum container, and comprises a breaker, a grounding switch and an isolator as said switching portions, said vacuum container being separated into at least two chambers, the switching portion of said breaker being disposed in one of said chambers, the switching portions of said grounding switch and said isolator being disposed in the other of said chambers, one end of said grounding switch and one end of said isolator being electrically connected to each other with a flexible member.

4. A vacuum switch which is formed by containing switching portions into a vacuum container, and comprises a breaker, a grounding switch and an isolator as said switching portions, said vacuum container being separated into at least two chambers, the switching portion of said breaker being disposed in one of said chambers, the switching portions of said grounding switch and said isolator being disposed in the other of said chambers, one end of said breaker and a main circuit member led outside said vacuum container being electrically connected to each other with a flexible member, one end of said grounding switch and one end of said isolator being electrically connected to each other with a flexible member.

5. A vacuum switch comprising a breaking portion in a vacuum container, one end of said breaking portion and a main circuit member led outside said vacuum container being electrically connected to each other with a flexible member.

6. A vacuum switch comprising a switching portion of an isolator and a switching portion of a grounding switch in a vacuum container, one end of the switching portion of said grounding switch and one end of the switching portion of said isolator being electrically connected to each other with a flexible member.

7. A complex vacuum switch comprising a vacuum breaker which has a breaking portion in a vacuum container, one end of said breaking portion and a main circuit member led outside said vacuum container being electrically connected to each other with a flexible member;
and a switching unit which has a breaking portion in a vacuum container, one end of said breaking portion and a main circuit member led outside said vacuum container being electrically connected to each other with a flexible member, wherein the other end of the switching portion of said breaker and the other end of the switching portion of said grounding switch are electrically connected to each other.

8. A vacuum switchgear which is formed by containing switching portions into a vacuum container, and comprises a breaker, a grounding switch and an isolator as said switching portions, said vacuum container being separated into at least two chambers, the switching portion of said breaker being disposed in one of said chambers, the switching portions of said grounding switch and said isolator being disposed in the other of said chambers, main circuit conductors and voltage detecting conductors being projected outward from said vacuum chamber having the switching portion of said breaker, main circuit conductors being projected outward from said vacuum chamber having the switching portion of said isolator, a projecting portion of each of said conductors being formed in a bushing covered with an electric insulating member, at least two of said bushings being formed in an equal shape.

9. A vacuum switchgear which is formed by containing switching portions into a vacuum container, and comprises a breaker, a grounding switch and an isolator as said switching portions, said vacuum container being separated into at least two chambers, the switching portion of said breaker being disposed in one of said chambers, the switching portions of said grounding switch and said isolator being disposed in the other of said chambers, one end of said breaker and a main circuit member led outside said vacuum container being electrically connected to each other with a flexible member, one end of said grounding switch and one end of said isolator being electrically connected to each other with a flexible member, main circuit conductors and voltage detecting conductors being projected outward from said vacuum chamber having the switching portion of said breaker, main circuit conductors being projected outward from said vacuum chamber having the switching portion of said isolator, a projecting portion of each of said conductors being formed in a bushing covered with an electric insulating member, at least two of said bushings being formed in an equal shape.

10. The vacuum switch according to any one of claim 2 to claim 7 or the vacuum switchgear according to claim 9, wherein said flexible member has a cross-sectional capable of withstanding a necessary current capacity, and is made of oxygen-free copper.

11. The vacuum switch or the vacuum switchgear according to claim 10, wherein said flexible member is a flexible conductor which is formed by laminating a plurality of oxygen-free copper plates and soldering both ends of the laminated plates.
